(19) United States
(12) Patent Application Publication
(10) Pub. No.: US 2009/0172686 A1
(43) Pub. Date: Jul. 2, 2009

(54) METHOD FOR MANAGING THREAD GROUP OF PROCESS

(76) Inventors: Chih-Ho Chen, Yongkang City (TW); Ran-Yih Wang, Taipei City (TW)

Correspondence Address: Muncy, Geissler, Olds & Lowe, PLLC, P.O. BOX 1364, FAIRFAX, VA, 22038-1364, US

(21) Appl. No.: 12/248,606

(22) Filed: Oct. 9, 2008

(30) Foreign Application Priority Data
Dec. 28, 2007 (TW) 096151032

(51) Int. Cl. G06F 9/46

(52) U.S. Cl. 718/103

(57) ABSTRACT

A method for managing a thread group of a process is provided. First, a group scheduling module is used to receive an execution permission request from a first thread. When detecting that a second thread in the thread group is under execution, the group scheduling module stops the first thread, and does not assign the execution permission to the first thread until the second thread is completed, and till then, the first thread retrieves a required shared resource and executes the computations. Then, the first thread releases the shared resource when completing the computations. Then, the group scheduling module retrieves a third thread with the highest priority in a waiting queue and repeats the above process until all the threads are completed. Through this method, when one thread executes a call back function, the other threads are prevented from taking this chance to use the resource required by the thread.

This application claims the benefit of Taiwan Patent Application No. 096151032, field on Dec. 28, 2007, which is hereby incorporated by reference for all purposes as if fully set forth herein.

### BACKGROUND OF THE INVENTION

1. Field of the Invention

The present invention relates to a thread management method, and more particularly to a method for managing a thread group of a process, which restricts the number of threads simultaneously executed in a thread group of the process and is combined with a priority rule.

2. Related Art

In general, one process allows a plurality of threads to exist together and to be executed simultaneously. When these threads need to access the same resource in the process, the phenomenon of resource contention and the race condition easily occur, which is generally overcome through a semaphore rule.

Referring to FIGS. 1A and 1B, they are respectively a schematic view showing a contention of a plurality of threads for one shared resource and a schematic view of a program coding. The process 110 includes a first thread 111, a second thread 112 and a third thread 113, and the three threads contend for one shared resource 120.

A process block of the process 110 is OldSample_( ) shown in FIG. 1B. The Sample_MGR( ) and the Call Back( ) need to control the shared resource 120 to calculate relevant data. When executing to the Sample_MGR( ), the first thread 111 first submits a semaphore request to obtain a control right of the shared resource, so as to access and to perform computation of the data. At this time, the shared resource 120 is under protection and cannot be accessed by the second thread 112 or the third thread 113 any more.

When a call back function (Call Back( ) is executed, if the call back function needs to retrieve the same shared resource 120, the first thread 111 fails to retrieve the shared resource since the shared resource is protected, thereby generating a deadlock. In order to avoid the above circumstance, the first thread 111 must first release the control right of the shared resource 120, i.e., to release the semaphore. In this manner, the semaphore is continuously submitted and released, such that the first thread 111 does not generate the deadlock and completes the required calculations when executing both Sample_MGR( ) and Call Back( ).

However, there are still other problems need to be solved, that is, when the first thread releases the semaphore in the Sample_MGR( ) to execute the Call Back( ) and releases the semaphore in the Call Back( ) to return to the Sample_MGR( ), the semaphore may be possibly retrieved by the second or third thread to perform data operation on the shared resource, thereby altering an original computation result of the first thread. However, since no technical feature for preventing the alteration of the computation result has been provided in the prior art, the first thread fails to obtain the correct computation data.

### SUMMARY OF THE INVENTION

Accordingly, the present invention is directed to a method for managing a thread group of a process, which is used for grouping threads and restricting that only one thread in the thread group is executed in the meantime, so as to avoid a deadlock and to prevent incorrect computation data.

In order to solve the above problems in the process execution, the technical means of the present invention is to provide a method for managing a thread group of a process. The process has at least one thread group, and each thread group corresponds to at least one shared resource. In this method, a group scheduling module is used to retrieve an execution permission request from a first thread and to detect whether an execution permission is given to other threads or not, so as to decide whether to assign the execution permission to the first thread or not. Then, the method further includes a step of detecting whether a second thread in the thread group is under execution or not, so as to decide whether to stop the first thread and to wait until the second thread is completed. Afterwards, the first thread is allowed to retrieve a required shared resource to complete computations of the first thread. After the execution of the first thread is completed, the group scheduling module retrieves the shared resource released by the first thread and determines whether a third thread with the highest priority in a third thread group is in a state of being stopped or not; and if yes, wakes up and executes the third thread with the highest priority.

In the method for managing a thread group of a process of the present invention, when the number of the third threads with the highest priority in a waiting queue is more than one, one of the threads is retrieved according to a limitation rule and then waked up to be executed. The limitation rule may be the First In First Out (FIFO) rule, Shortest Job First Scheduling (SJF) rule, or Round-Robin Scheduling (R.R) rule.

The present invention has the following efficacies that cannot be achieved by the prior art.

First, only one thread of the thread group is allowed to compute in the meantime to avoid the resource contention and race condition.

Second, when the group scheduling module detects that a thread is under execution or not completed yet, the group scheduling module stops the other threads, and enables the thread under execution to complete the computation and then release the shared resource. Therefore, the shared resource released by the thread is prevented from being retrieved by other threads during the idle period rather than altering,internal data of the thread under execution, resulting in obtaining incorrect computation data and incorrect computation results.

### BRIEF DESCRIPTION OF THE DRAWINGS

The present invention will become more fully understood from the detailed description given herein below for illustration only, which thus is not limitative of the present invention, and wherein:

FIG. 1A is a schematic view showing a contention of threads for one shared resource in the prior art;

FIG. 1B is a schematic view of a program coding in the prior art;

FIG. 2A is a flow chart of a thread group management method according to an embodiment of the present invention;

FIG. 2B is a detailed flow chart of the thread group management method according to an embodiment of the present invention;

FIG. 2C is a detailed flow chart of the thread group management method according to an embodiment of the present invention;

FIG. 3A is a schematic view of a thread group configuration according to an embodiment of the present invention;

FIG. 3B is a schematic view of contention for one shared resource according to an embodiment of the present invention; and

FIG. 3C is a schematic view of a program coding according to an embodiment of the present invention.

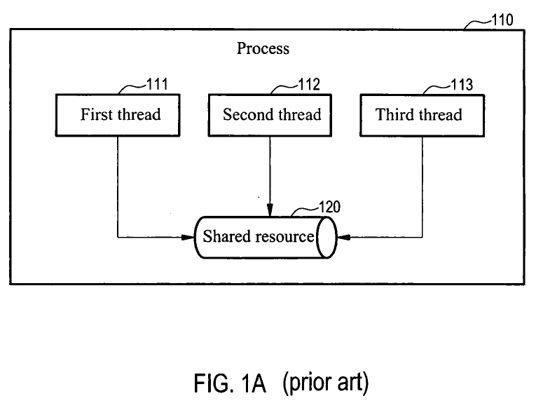

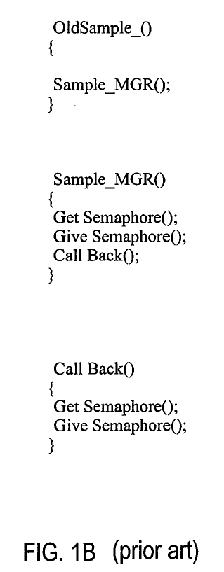

### DETAILED DESCRIPTION OF THE INVENTION

To make the objectives, structural features, and functions of the present invention become more comprehensible, the present invention is illustrated below in detail through relevant embodiments and drawings.

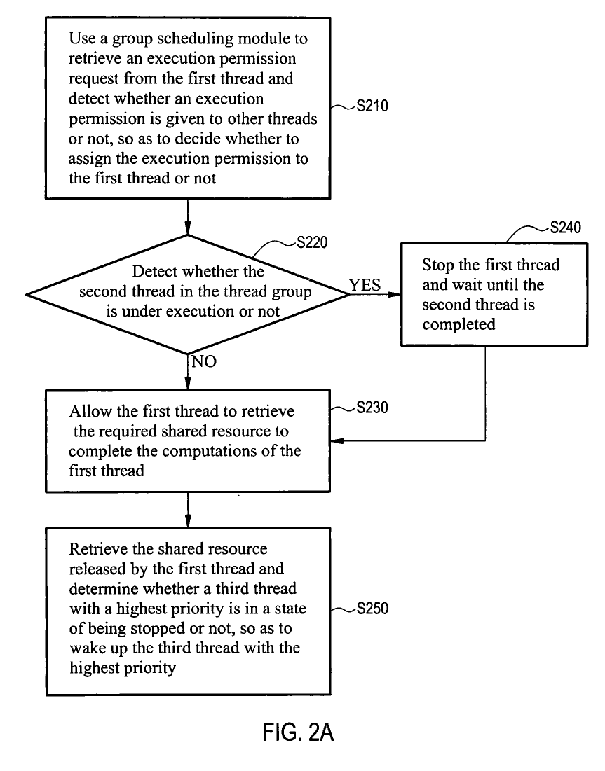

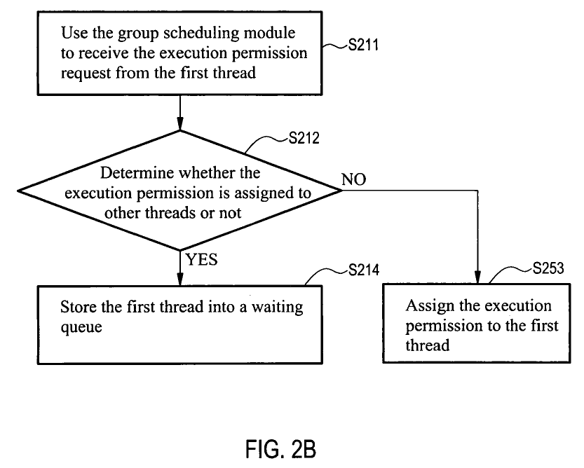

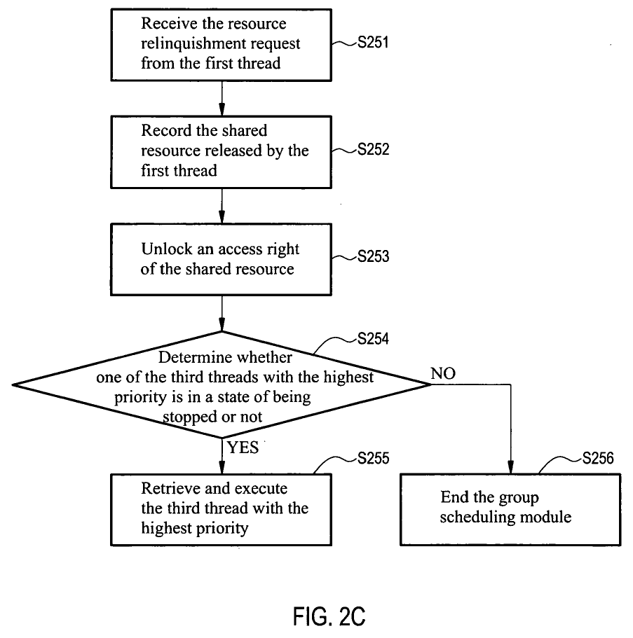

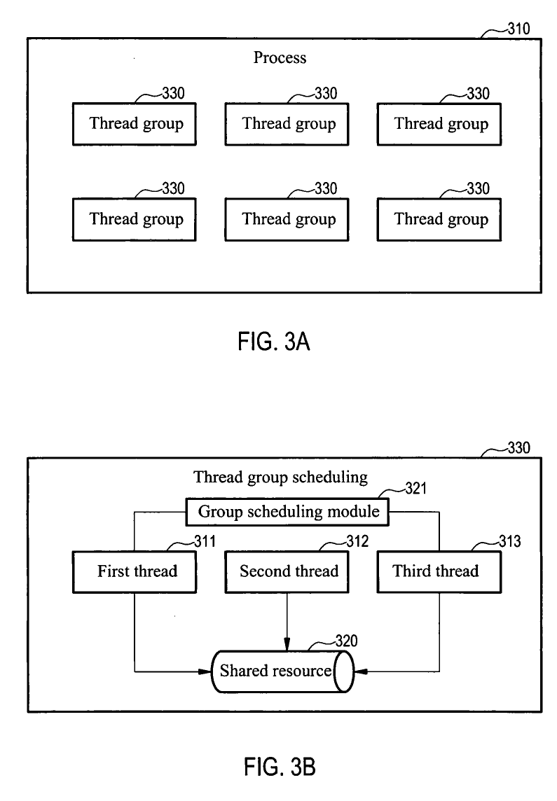

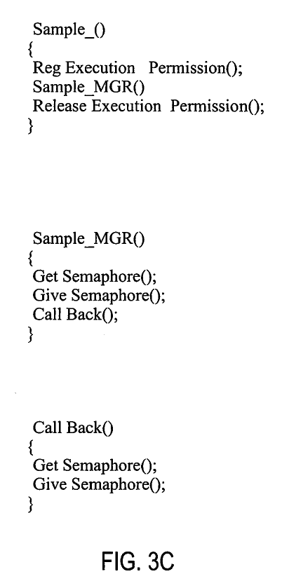

Referring to FIGS. 2A, 2B, and 2C, they are respectively a flow chart and detailed flow charts of a method for managing a thread group of a process according to an embodiment of the present invention, together with FIG. 3B, which facilitates the illustration. In this method, a first thread 311 is the thread that sends an execution permission request. A second thread 312 is the thread under execution. A third thread 313 is the thread in waiting state. The method includes the following steps.

A group scheduling module 321 is used to retrieve an execution permission request from the first thread 311 and to detect whether an execution permission is given to other threads (the second thread 312 and the third thread 313) or not, so as to decide whether to assign the execution permission to the first thread 311 or not (Step S210).

The group scheduling module 321 is used to receive the execution permission request from the first thread 311 (Step S211) in advance. The first thread 311 is a thread newly generated by a process 310 or the third threads 313 previously in waiting state, and the one with the highest priority among all the third threads 313 is retrieved from the third threads 313. The execution permission includes a control right of a shared resource 320. The shared resource 320 refers to hardware and software that can be used by the system. The hardware is a physical device such as a hard disk, a floppy disk, a display card, a chip, a memory, and a screen. The software is a program such as a function, an object, a logic operation element, and a subroutine formed by program codes. Retrieving the shared resource 320 represents obtaining the control right of a certain physical device or a certain program of the system.

The group scheduling module 321 determines whether the execution permission is assigned to other threads or not (Step S212), and if not, the group scheduling module 321 assigns the execution permission to the first thread 311 (Step S213); otherwise, stores the first thread 311 into a waiting queue (Step S214).

When storing the first thread 311, the group scheduling module 321 stops the execution of the first thread 311, then gives an authority value to the first thread 311, and finally adds the first thread 311 into the waiting queue.

When the first thread 311 starts to be executed, the group scheduling module 321 first detects whether the second thread 312 in the thread group 330 is under execution or not (Step S220) in the following two manners.

First, it is detected whether the shared resource 320 is occupied by the second thread 312 or not or a relevant function or object is being executed, that is because when any of the threads is executed, either the shared resource 320 is occupied or the function or object is executed.

Second, it is detected whether any shared resource 320 is restricted by the second thread 312 or not. When any of the threads is executed, the group scheduling module 321 restricts the required shared resource 320 to prevent the required shared resource 320 from being occupied by other threads until the execution of second thread 312 is completed. In another word, the shared resource 320 temporarily released by the second thread 312 is prevented from being occupied by other threads while calling a function or executing a call back function.

If no second thread 312 is determined to be under execution, the first thread 311 is allowed to retrieve the required shared resource 320, so as to complete the computations of the first thread 311 (Step S230); if the second thread 312 is determined to be under execution, the first thread 311 is stopped and waits until the second thread 312 is completed (Step S240), and then Step S230 is performed.

This step mainly aims at preventing the group scheduling module 321 from giving the control right of the shared resource 320 to the first thread 311 by mistake since it retrieves a resource relinquishment request while the second thread 312 executes the call back function or the subroutine to release the shared resource 320. Therefore, upon determining that any second thread 312 is under execution and not completed yet, the first thread 311 is stopped, such that the previously executed second thread 312 may continuously retain the shared resource 320 to complete its task.

The shared resource 320 released by the first thread 311 is retrieved and it is determined whether a third thread 313 with a highest priority is in a state of being stopped or not, so as to wake up the third thread 313 with the highest priority (Step S250). In this step, the group scheduling module 321 receives the resource relinquishment request from the first thread 311 (Step S251), then records the shared resource 320 released by the first thread 311 (Step S252), and finally unlocks an access right of the shared resource 320 (Step S253) for being used by other threads.

Then, in the process of detecting whether one of the third threads 313 with the highest priority is in a state of being stopped or not (Step S254), as described above, if those threads previously determined as non-executable or those forced to be stopped are all stored into the waiting queue, it merely needs to detect whether a third thread 313 with the highest priority is stored in the waiting queue or not, if not, the group scheduling module 321 is ended (Step S256); otherwise, the third thread 313 with the highest priority is retrieved from the waiting queue and executed (Step S255).

However, the group scheduling module 321 first detects whether the number of the third threads 313 with the highest priority is only one or not (as a matter of fact, the highest priority is provided), and if yes, Step S255 is performed; otherwise, the group scheduling module 321 retrieves and executes one of the third threads 313 with the highest priority according to a limitation rule. The limitation rule is one of the following rules:

first, a First In First Out (FIFO) rule, in which a thread that is earliest stored into the waiting queue is retrieved among a plurality of threads with the highest priority and is executed;

second, a Round-Robin Scheduling (R.R) rule, in which a thread is retrieved and executed according to a waiting sequence; and

third, a Shortest Job First Scheduling (SJF) rule, in which a predetermined execution time for each of the threads is calculated and a thread with the shorted execution time is selected.

Referring to FIGS. 3A to 3C, they are respectively a schematic view of a thread group configuration according to an embodiment of the present invention, a schematic view of contention for one shared resource, and a schematic view of a program coding.

Referring to FIGS. 3A and 3B, the process 310 includes at least one thread group 330, and each thread group 330 includes at least one thread and a group scheduling module 321, which is corresponding to one shared resource 320. The group scheduling module 321 manages the threads to decide which thread may get the shared resource 320.

The Sample( ) shown in FIG. 3C is the main process codes of the process 310, in which the Sample_MBR( ) is the subroutine. The Call Back( ) is set as the call back function. The Reg Execution Permission( ) is used to protect the shared resource 320 required by the Sample_MBR( ), so as to restrict the shared resource 320 that is utilized by a thread executing the Sample_MBR( ). The Release Execution Permission( ) is used to release the shared resource 320 required for executing the Sample_MBR( ).

When the first thread 311 executes the subroutine Sample_MBR( ) in the process block of the process 310, the shared resource 320 required by the first thread 311 is protected through the Reg Execution Permission( ), and meanwhile, an execution permission request (i.e., the control right of the shared resource 320; Get Semaphore( )) is sent to the group scheduling module 321 until the computations are completed.

If the call back function Call Back( ) needs to be executed during the process 310, the first thread 311 first releases the control right of the shared resource 320 (i.e., submitting a resource relinquishment request; Give Semaphore), and then executes the call back function Call Back( ). When executing the call back function, the first thread 311 similarly needs to submit the execution permission request and resource relinquishment request, so as to retrieve or release the control right of the shared resource 320, thereby avoiding deadlock. Afterwards, the first thread 311 returns to the Sample_MBR( ) to complete the computations of the first thread 311, and finally returns to the Sample( ) and executes the Release Execution Permission( ) to release the protection of the shared resource 320.

When the first thread 311 gets the execution permission and the second thread 312 is added in the same thread group 330, the group scheduling module 321 stops the execution of the second thread 312 and gives an authority value to the second thread 312, and finally adds the second thread 312 into a waiting queue (not shown).

In addition, during the idle period for the first thread 311 switching back and forth between the Sample_MBR( ) and the Call Back( ), the group scheduling module 321 may misjudge that the first thread 311 has been completed due to the resource relinquishment request submitted by the first thread 311, resulting in giving the execution permission to the second thread 312 in waiting or the newly-added third thread 313.

However, the shared resource 320 required by the first thread 311 is protected through the Reg Execution Permission( ), such that the second thread 312 or the third thread 313 fails to get the shared resource 320 required by the first thread 311. Meanwhile, the group scheduling module 321 is informed that the first thread 311 has not been completed yet, so as to stop the execution of the second thread 312 or the third thread 313 and return to the waiting queue to wait until the first thread 311 finishes all the computations.

Afterwards, the group scheduling module 321 records the shared resource 320 released by the first thread 311, retrieves the thread with the highest authority value from the second thread 312 and the third thread 313, and wakes up and executes the thread with the highest authority value.

When both the second thread 312 and the third thread 313 are completed, the group scheduling module 321 does not get a new thread and none of the threads exists in the waiting queue, the group scheduling module 321 ends its own task.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for managing a thread group of a process, comprising:
using a group scheduling module to retrieve an execution permission request from a first thread and to detect whether an execution permission is given to other threads or not, so as to decide whether to assign the execution permission to the first thread or not;
detecting whether a second thread in the thread group is under execution or not, so as to decide whether to stop the first thread and wait until the second thread is completed;
allowing the first thread to retrieve a required shared resource to complete computations of the first thread; and
retrieving the shared resource released by the first thread and determining whether a third thread with a highest priority is in a state of being stopped or not, so as to wake up the third thread with the highest priority.

2. The method for managing a thread group of a process as claimed in claim 1, wherein the step of detecting whether a second thread in the thread group is under execution or not comprises:
detecting whether the shared resource is occupied by the second thread or not, and if yes, stopping the first thread and waiting until the second thread is completed; otherwise, allowing the first thread to retrieve the required shared resource to complete the computations of the first thread.

3. The method for managing a thread group of a process as claimed in claim 1, wherein the step of detecting whether a second thread in the thread group is under execution or not comprises:
detecting whether any shared resource is restricted by the second thread or not, and if yes, stopping the first thread and waiting until the second thread is completed; otherwise, allowing the first thread to retrieve the required shared resource to complete the computations of the first thread.

4. The method for managing a thread group of a process as claimed in claim 1, wherein the step of deciding whether to assign the execution permission to the first thread or not comprises:
using the group scheduling module to receive the execution permission request from the first thread; and
determining whether the execution permission is assigned to other threads or not, and if not, assigning the execution permission to the first thread; otherwise, storing the first thread into a waiting queue.

5. The method for managing a thread group of a process as claimed in claim 4, wherein the step of storing the first thread into a waiting queue further comprises:
stopping an execution of the first thread;
giving an authority value to the first thread; and
adding the first thread into the waiting queue.

6. The method for managing a thread group of a process as claimed in claim 1, wherein the step of retrieving the shared resource released by the first thread comprises:
receiving a resource relinquishment request from the first thread;
recording the shared resource released by the first thread; and
unlocking an access right of the shared resource.

7. The method for managing a thread group of a process as claimed in claim 1, wherein the step of determining whether a third thread with a highest priority is in a state of being stopped or not comprises:
if the third thread with the highest priority is determined to be in the state of being stopped, retrieving and executing the third thread with the highest priority.

8. The method for managing a thread group of a process as claimed in claim 7, wherein the step of retrieving and executing the third thread with the highest priority comprises:
detecting whether a number of the third threads with the highest priority is only one or not, and if not, retrieving and executing one of the third threads according to a limitation rule; otherwise, retrieving and executing the third thread with the highest priority.

9. The method for managing a thread group of a process as claimed in claim 8, wherein the limitation rule is a First In First Out (FIFO) rule.

10. The method for managing a thread group of a process as claimed in claim 8, wherein the limitation rule is a Round-Robin Scheduling (R.R) rule.

11. The method for managing a thread group of a process as claimed in claim 8, wherein the limitation rule is a Shortest Job First Scheduling (SJF) rule.

12. The method for managing a thread group of a process as claimed in claim 1, wherein each thread group corresponds to at least one shared resource.

13. The method for managing a thread group of a process as claimed in claim 1, wherein when the first thread retrieves the required shared resource, and the group scheduling module restricts the shared resource that is utilized by the first thread until the first thread is completed.
